(19) United States
(12) Patent Application Publication
(10) Pub. No.: US 2011/0126929 A1
(43) Pub. Date: Jun. 2, 2011

(54) Microstructures For Fluidic Ballasting and Flow Control

(75) Inventors: Luis F. Velasquez-Garcia, Boston, MA (US); Akintunde I. Akinwande, Newton, MA (US)

(73) Assignee: MASSACHUSETTS INSTITUTE OF TECHNOLOGY, Cambridge, MA (US)

(21) Appl. No.: 12/673,191

(22) PCT Filed: Aug. 14, 2008
(86) PCT No.: PCT/US08/09749

§ 371 Date: Feb. 18, 2011

Related U.S. Application Data
(60) Provisional application No. 60/964,827, filed on Aug. 15, 2007.

(51) Int. Cl. F03B 15/00

(52) U.S. Cl. 137/561 R

(57) ABSTRACT

In one example hydraulic ballast of the invention there is provided an input port and an output port through which a prespecified output flow rate is required. There is provided between the input and output ports a ballasting array of columns having a cross-sectional column extent, W, a column pitch, P, and an array length, L, selected based on the required output flow rate, to produce a prespecified pressure drop that enforces the required output flow rate.

### CROSS-REFERENCE TO RELATED APPLICATION

This application claims the benefit of U.S. Provisional Application No. 60/964,827, filed Aug. 15, 2007, the entirety of which is hereby incorporated by reference.

### STATEMENT REGARDING FEDERALLY SPONSORED RESEARCH

This invention was made with Government support under Contract No. W911QY-05-1-0002 awarded by DARPA. The Government has certain rights in the invention.

### BACKGROUND OF INVENTION

This invention relates generally to microscale and nanoscale fluidic systems, and more particularly relates to flow control in microscale and nanoscale fluidic systems.

There is a wide range of fluidic systems for which scaling down of system features to the microscale provides important advantages. For example, chemical reactors, which bring together reactants that produce a chemical reaction, benefit from scaling down of chemical injectors and reactor packed beds to the microscale because the surface area per unit reaction volume increases as the system size is decreased, resulting in an enhancement of mass transport in the system. This mass transport enhancement corresponds to a decrease in diffusion length and a corresponding decrease in required diffusion time in the reaction volume, producing a more efficient reaction system. Also, the products of a scaled down reactor have less residence time, which could further increase the efficiency of the reactor if deactivation losses are present. Microscale chemical reactors can be used for a wide range of processes, such as laser generation, power generation, chemical synthesis, separation, chemical detection, propulsion, and other processes. Biological molecular analysis, replication, sequencing, detection, and other such processes can also be implemented with microscale reactor arrangements.

Similarly, microscale electrospray device performance is enhanced by virtue of its microscale dimensions. Microscale electrospray devices enable the soft ionization of liquids for a wide range of applications, including, e.g., printing, etching, combustion, propulsion, liquid chromatography, spray generation, electrospinning, coating, and mass spectrometry of biological molecules such as proteins and DNA. Electrospray source performance is enhanced by scaling down of spray emitter dimensions because such scaling reduces the required startup voltage and reduces vaporization losses of the device; the start-up voltage of an emitter is proportional to first order to the square root of the emitter outer diameter, and vaporization losses scale with the square of the emitter inner diameter.

Electrospray emitter performance is also enhanced by a configuration of an array of microscale emitters. If the electrospray emitter operation is in the single Taylor cone droplet regime, then the net emitted current is increased by a factor equal to the square root of the number of clustered emitters, assuming uniform per-emitter emission. This enhancement in emitted current can be very advantageous for electrospray applications. For example, a microscale electrospray emitter cluster for liquid chromatography generates a larger signal than a single electrospray emitter for the same analyte flow rate.

Fluidic flow control is critical in microscale systems such as the chemical reactors and electrospray devices described above. The increased surface area-to-volume ratio of microscale systems requires precise control of fluid flow and pressure. This is particularly true for microscale fluidic applications in which multiple microfluidic device units or systems are provided in an assembly or clustered arrangement, as in an electrospray array or chemical reactor cluster. Here each device in the array or cluster is optimally controlled individually such that the flow of the overall array or cluster meets the operational requirements of a given application.

For example, in an array of electrospray emitters, flow control must be achieved individually for each of the emitters in the array. Such emitter-specific fluidic flow control is required to avoid emitter cross talk that could result in only a few emitters of the array working, and to ensure that each emitter will successfully operate within the range of flow rates permitted for a given application. For many applications, the properties of the electrospray liquid fan produced by an emitter are highly dependent on the flow rate of the emitter. For example, in the single Taylor cone droplet emission mode, the emitter flow rate range scales with the inverse of the electrical conductivity of the liquid, and pure ionic emission of electrospray sources will only be guaranteed for emitter flow rates below a specified maximum flow rate.

As a result of operational and performance constraints like those discussed above, fluidic flow must be precisely controlled in microscale fluidic devices and clusters of such devices. Without device-specific, microscale fluidic flow control, microscale fluidic systems cannot achieve the important performance advantages they offer over macroscale counterparts.

### SUMMARY OF THE INVENTION

The invention provides fluidic ballasting structures that overcome limitations of conventional techniques for controlling fluid flow, and that can be implemented in the microscale and nanoscale regimes. In one example hydraulic ballast of the invention there is provided an input port and an output port through which a prespecified output flow rate is required. There is provided between the input and output ports a ballasting array of columns having a cross-sectional column extent, W, a column pitch, P, and an array length, L, selected based on the required output flow rate, to produce a prespecified pressure drop that enforces the required output flow rate.

This ballast can be configured in a fluidic element array including a plurality of fluidic elements where each element includes an input port and an output port through which a prespecified output flow rate is required. A reservoir is connected for delivery of a fluid from the reservoir to each fluidic element input port. An hydraulic ballast structure is provided for each fluidic element and connected between the input port and the output port of each fluidic element, distinct to that element. The hydraulic ballast structure includes an array of columns having a column extent, W, a column pitch, P, and an array length, L, selected based on the required output flow of that element, to produce a prespecified pressure drop that enforces the required output flow for that element.

For a wide range of fluidic applications, the ballast structure of the invention enables an ability to implement a particular and prespecified pressure drop and controlled flow rate for given operational dimensions and environment. Other features and advantages of the invention will be apparent from the following description and accompanying figures, and from the claims.

### BRIEF DESCRIPTION OF THE DRAWINGS

FIGS. 1A-1C are a block diagram and schematic perspective and side views, respectively, of an example ballasting array provided by the invention;

FIG. 2 is a schematic view of a partially liquid-filled fluidic tube for analysis of the ballasting array of the invention;

FIGS. 3A-3B are schematic top-down large-scale and magnified views, respectively, of an example ballasting array provided by the invention;

FIG. 4 is a plot of normalized fluid permeability as a function of porosity for an example ballasting array of the invention;

FIGS. 5A-5B are schematic perspective views of example ballasting arrays provided by the invention;

FIGS. 6A-6C are schematic side views of example flow paths in which ballasting arrays of the invention are provided;

FIG. 7 is a schematic perspective view of an electrospray emitter including the ballasting array of the invention implemented in a channel of the emitter;

FIGS. 8A-8C are cross-sectional side-views and plan views, respectively, of a microscale electrospray emitter array including microscale ballasting arrays in accordance with the invention;

FIG. 9 is a plot of electrical breakdown in air and a plot of required startup voltage, both as a function of emitter-to-gate separation for the electrospray emitters of FIGS. 8A-8C;

FIG. 10 is a plot of emitted array current as a function of total flow rate for the electrospray emitters of FIGS. 8A-8C;

FIG. 11 is a plot of specific charge as a function of total flow rate for the electrospray emitters of FIGS. 8A-8C;

FIG. 12 is a plot of total power as a function of total flow rate for the electrospray emitters of FIGS. 8A-8C;

FIG. 13 is a plot of ballasting array pressure as a function of ballasting array pillar diameter for a ballasting pillar array of the invention having a pillar pitch of 10 μm;

FIG. 14 is a schematic cross sectional view of the electrospray emitters of FIG. 8A, here with example design dimensions shown;

FIG. 15 is a schematic perspective, exploded view of an example archetypical electrospray emitter array including the ballasting structure of the invention; and

FIGS. 16A-16E are schematic cross-sectional side views of a silicon wafer at steps of an example microfabrication process provided by the invention for producing a microscale ballasting array in accordance with the invention.

### DETAILED DESCRIPTION OF THE INVENTION

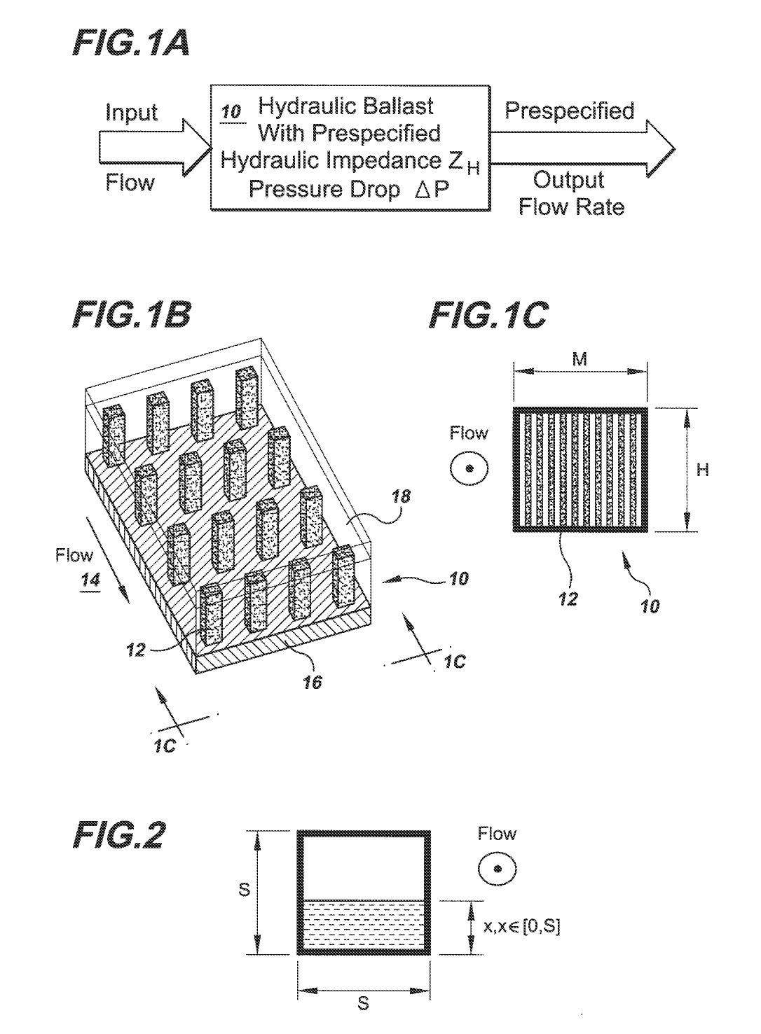

Referring to FIG. 1A, there is schematically represented the operation of the hydraulic ballast of the invention. The hydraulic ballast 10 is designed, in the manner described below, to provide a prespecified hydraulic impedance, Z_{H}, and a prespecified pressure drop, ΔP. An input of fluid or gas flows through the hydraulic ballast and experiences the prespecified pressure drop of the ballast. This pressure drop in the flow results in the production of a prespecified flow rate out of the ballast. The hydraulic ballast thereby imposes a prespecified pressure drop on the input flow for a corresponding prespecified output flow rate. As explained in detail below, this ballasting configuration of the invention can be implemented for a single hydraulic element or can be implemented for each element in an array of elements, with the ballasting configuration customized to produce the output flow rate required for each element.

Also referring to FIGS. 1B-1C, there is schematically shown an example microscale fluidic ballasting configuration provided by the invention. The ballast is illustrated in this example as an array 10 of columns or pillars 12 that are arranged in the flow path 14 of a fluid. To enable an initial explanation of the ballasting structure design and operation, the array is shown schematically as being supported on a platform or substrate 16 and having a top enclosing surface 18 and sidewalls. This configuration can be defined as a tube having a constant rectangular cross section of width M and height H, within which are provided an array of substantially square columnar obstacles 12, as shown end-on in FIG. 1C. The array of pillars 12 acts as ballast that imposes a hydraulic impedance on the fluid as the fluid flows through the array, between the pillars, perpendicular to the cross section of the pillars, to produce a desired pressure drop in the fluid. As explained in detail below, the invention provides an ability to specify the geometry of the ballasting pillar array such that a prespecified fluidic pressure drop and fluid flow can be purposefully imposed by the specified geometry.

To understand the operation of this fluidic ballasting configuration of the invention, first consider that there are two characteristic lengths that are sufficient to describe the hydraulic behavior of a fluidic system: the flow length, L, which is the effective distance of a fluid flow through a hydraulic impedance under consideration, and the hydraulic diameter, D_{H}, of the fluid flow along that flow length. The hydraulic impedance, Z_{H}, of the fluidic system can be given as

$${Z}_{H} = \frac{Δ P}{Q} , \qquad ( 1 )$$

where ΔP is the pressure drop across the hydraulic impedance and Q is the flow rate of the fluid through the impedance. For a Newtonian liquid, the hydraulic impedance, Z_{H}, can be given as:

$${Z}_{H} = C \frac{L}{{D}_{H}^{4}} , \qquad ( 2 )$$

where L is the effective length that the flow travels through the hydraulic impedance and C is a constant dependent on the viscosity of the liquid and the geometry of the hydraulic impedance element, which sets a particular flow field distribution that is reflected in the magnitude of the hydraulic impedance. The hydraulic diameter is given as:

$${D}_{H} = 4 \frac{A}{{P}_{w}} , \qquad ( 3 )$$

where A is the cross sectional area of fluid flow, and P_{w} is the wetted perimeter of the fluid flow.

For example, the hydraulic diameter, D_{H}, of a fully filled pipe with circular cross-section is equal to the pipe's inner diameter Dᵢ, while the hydraulic diameter of a fully filled pipe with square cross-section is equal to the length, S, of one side of the square pipe.

Now consider a partially-filled tube of constant square cross section like the one shown schematically in FIG. 2. Here, the hydraulic diameter, D_{H}, can be expressed as a function of filled height, x, ranging from 0 to S, as:

$${D}_{H} = 4 \frac{A}{{P}_{w}} = 4 \frac{S \cdot x}{S + 2 \cdot x} ; {D}_{H} ∈ [ 0 , S ] , \qquad ( 4 )$$

where the maximum possible hydraulic diameter, D_{H}, for this tube is equal to the length of one side of the square, S, as above.

Now turning back to the ballasting structure of the invention, as shown in FIG. 1, the ballasting pillar array 10 of the invention is a three-dimensional structural impedance imposed in a path of fluid flow. The cross section of a fluid flow path including the ballasting structure is therefore not open space, but instead includes periodic structures, operating as obstacles to fluid flow, in the form of, e.g., pillars, columns, or other geometry.

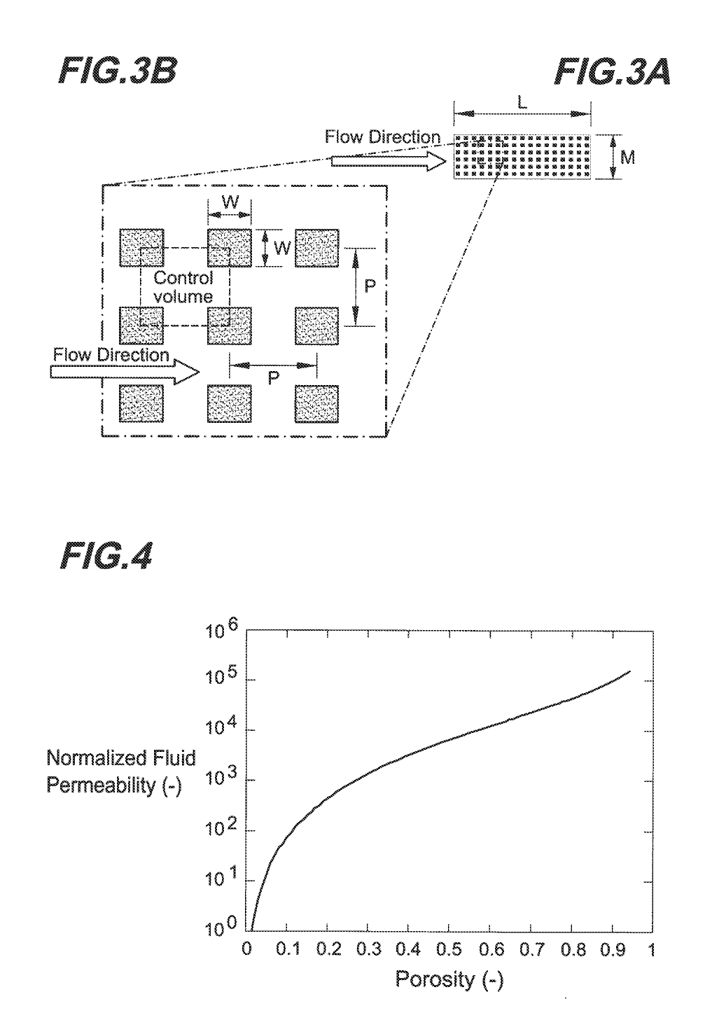

Referring also to FIGS. 3A-3B, to analyze the operation of this ballasting structure of the invention, consider a tube like that of FIG. 1C, with constant rectangular cross section of width M and height H, and with tube length L, as shown in the schematic top-down view of FIG. 3A. FIG. 3B illustrates a magnified top-down view of a section of the tube of FIG. 3A. Here it is shown that the tube includes an array of substantially square columns, each column having a side of length W, a height H, and a column-to-column pitch, P, as identified in FIG. 3B.

For this ballasting configuration of the invention, the hydraulic diameter, D_{H}, can be expressed in general, as:

$${D}_{H} = 4 \frac{V}{{A}_{w}} , \qquad ( 5 )$$

where V is the volume occupied by the fluid and A_{w} is the wetted area of the tube. For the case of a tube with constant cross section that has no obstacles, Expression (5) simplifies to Expression (3) as:

$${D}_{H} = 4 \frac{V}{{A}_{w}} = 4 \frac{A \cdot d x}{{P}_{w} \cdot d x} = 4 \frac{A}{{P}_{w}} , \qquad ( 6 )$$

where dx is an arbitrary distance along the flow direction. Applying Expression (5) in a controlled volume as shown in FIGS. 3A-3B, the hydraulic diameter, D_{H}, can be expressed as:

$${D}_{H} = 4 \frac{V}{{A}_{w}} = \frac{4 \cdot ( {P}^{2} - {W}^{2} ) \cdot H}{4 \cdot W \cdot H + 2 ( {P}^{2} - {W}^{2} )} . \qquad ( 7 )$$

This expression directly relates the hydraulic diameter, D_{H}, with the pillar width, pillar height, and pillar pitch for the example square pillar example of FIGS. 3A-3B. In accordance with the invention, this relationship enables the exact specification of a ballasting pillar array like that of FIG. 1B to achieve a desired hydraulic diameter, D_{H}, and corresponding hydraulic impedance, Z_{H}, pressure drop, ΔP, across the ballasting pillar array, for a flow rate, Q, of the fluid through the array once an hydraulic ballasting element geometry is specified. The invention thereby provides the ability to a priori specify a desired pressure drop and flow rate and to enforce the desired pressure drop in a well-defined and reliable manner with the ballasting array of the invention.

The model employed by the invention to enable this design specification for producing the ballasting array of the invention is based on several criteria. First, referring to the parameters identified in FIGS. 3A-3B, the cross-sectional extent, e.g., diameter, or width, of a ballasting array pillar is at least about 50% of the array pitch; i.e., for the square-column array of FIGS. 3A-3B, W>0.5P. The length of the array, L, is greater than about ten times the pitch; i.e., L>10×P. The height of the array columns, H, as shown in FIG. 1C, is greater than about ten times the column width; i.e., for the square-column array of FIGS. 3A-3B, H>10×W. If the fluid includes particles, it can be preferred for most applications that the gap between the columns be larger than the particles to avoid clogging of the structure.

Now, based on these criteria and the corresponding expressions above, consider for the example application shown in FIGS. 1A-1C of square pillars, that the pitch of pillars of the ballasting array, P, relative to each pillar width, W, is set as P≧W. If the tube height, H, relative to pillar pitch is set as H >>P, then Expression (7) can be simplified to:

$${D}_{H} = \frac{( {P}^{2} - {W}^{2} )}{W} = ( P + W ) ( P / W - 1 ) \qquad ( 8 )$$

Under the conditions assumed for Expression (8), the effective hydraulic diameter, D_{H}, of the flow region including the ballasting pillar array can be set very low, and even close to zero. This in turn produces a very high hydraulic impedance, Z_{H}, as given in Expression (2) above, because the hydraulic impedance is inversely proportional to the fourth-power of the hydraulic diameter. Attainment of this condition is important for many fluidic applications that require a very small flow rate, e.g., an array of electrospray devices requiring a very low per-emitter flow rate. Also demonstrated by this example, referring again to Expression (1), the flow rate through a ballasting structure of relatively larger hydraulic impedance provides reduced sensitivity to fluctuations in the flow pressure.

This example of the prespecified design of a high impedance ballasting structure demonstrates that in accordance with the invention, the pitch, P, and width, W, of pillars in a ballasting structure of the invention can be precisely selected for a selected fluidic tube height, H, and array length, L, to obtain a desired hydraulic diameter, D_{H}, and corresponding hydraulic impedance, Z_{H}. As explained above, and referring again to Expression (1), the ballasting structure of the invention thereby enables selection of a specific pressure drop across the ballasting structure for a given fluidic flow rate.

Further, as explained in detail below, scaling-down the characteristic lengths of the hydraulic impedance of the invention to the microscale enables accommodation of a dense planar array of ballasted fluidic devices because for a required hydraulic impedance, a relatively smaller effective hydraulic diameter requires a smaller hydraulic impedance length, as shown by Expression (2) above. As a result, the length of the array of ballasting structures of the invention can be correspondingly small.

For ballasting array pillars with an arbitrary cross section, an approximate solution in the analysis above can be found by replacing the characteristic extent, W, of a square pillar cross section with an equivalent characteristic extent for the selected pillar cross-section. If the columns have constant cross-section, the equivalent characteristic pillar extent, D_{W}, can be computed as:

$${D}_{W} = 4 \frac{{A}_{CS}}{{P}_{CS}} \qquad ( 9 )$$

Where A_{CS} is the area of the pillar cross section, and P_{CS} is the perimeter of the pillar cross section. If the columns are tapered, then the equivalent characteristic extent of the pillar can be calculated as:

$${D}_{W} = 4 \frac{{V}_{C}}{{A}_{C}} \qquad ( 10 )$$

where V_{C} is the volume of the column and A_{C} is the surface area of the column. Both Expressions (9) and (10) result in a pillar extent, W, as the equivalent extent D_{W} for the case of a column having a uniform square cross section of square side W.

With this general design paradigm, the invention enables specification of a ballast structure pressure drop for a range of structure geometries. For a wide range of microscale fluidic applications, this ability to implement a particular and prespecified pressure drop and controlled flow rate in a microscale environment of limited length is critically important for successful operation of the fluidic system. The ballasting structure of the invention enables the a priori specification and design of a structural hydraulic impedance that guarantees the pressure drop and flow rate required for a given application and operational dimensions.

The analysis of flow through a ballasting structure of the invention can be expanded by considering the solution of the flow field around the pillars of the ballasting array. This framework allows the precise determination of the dependence of the hydraulic impedance on the geometry of the hydraulic ballasting element. For purposes of analysis, a pillar array like that of FIGS. 1B and 3B can be considered to provide a monodisperse nanostructured configuration having a characteristic permeability. The flow, \vec{v}, through such a configuration is described by Darcy's law as:

$${v}^{->} = - \frac{{K}_{p}}{μ} {∇}^{->} P \qquad ( 11 )$$

where P is the pressure, Kₚ is the permeability, μ is the dynamic viscosity, i.e., the proportionality constant between the shear stress and the velocity gradient perpendicular to the shear stress. Using mass conservation in a steady state for an incompressible fluid, the flow through the array of columns is described as:

∇²P=0 (12)

Expression (12) can be used to calculate the flow rate, Q, across the hydraulic impedance if the flow rate is integrated across the flow area, i.e.:

$$Q = {\int \int }_{flow\_area} {v}^{->} d A = - {\int \int }_{flow\_area} \frac{{K}_{p}}{μ} {∇}^{->} P d A \qquad ( 13 )$$

where dA is a differential of area. Using the definition of hydraulic impedance shown in Expression (1), Expression (13) can be used to calculate the corresponding hydraulic impedance as:

$${Z}_{H} = \frac{Δ P}{Q} = \frac{{\int }_{flow\_length} {∇}^{->} P \cdot d s}{{\int \int }_{flow\_area} \frac{{K}_{p}}{μ} {∇}^{->} P \cdot d A} \qquad ( 14 )$$

where ds is a differential of length along the flow path. Expression (14) can be simplified if the pressure gradient is constant, or if the flow field has symmetry.

There is an exact solution of the permeability for the case of an array of evenly spaced columns with a sufficiently high aspect ratio to allow the modeling as a 2-D problem. For the criteria imposed for the column array that was previously described, this is satisfied.

In the case of an array of uniformly spaced columns having a circular cross-section, the lubrication theory predicts that the permeability is given as:

$${K}_{p} = \frac{{D}^{2}}{12} \cdot \frac{{[ 1 - {Ω}^{2} ]}^{2}}{{Ω}^{3}} \cdot {[ 3 Ω \frac{{tan}^{- 1} [ \sqrt{\frac{1 + Ω}{1 - Ω}} ]}{\sqrt{1 - {Ω}^{2}}} + \frac{1}{2} {Ω}^{2} + 1 ]}^{- 1} , \qquad ( 15 )$$

where D is the column diameter and Ω is the ratio of the column diameter and the column-to-column separation, i.e., pitch. The column diameter D here is the same parameter as D_{W} from Expressions (9) and (10). Expression (15) defines a design space with multiple solutions, which can be turned into a unique solution if the column array parameters are specified in accordance with the invention, as in Expression (7) above, for designing a pillar array, namely, pillar diameter, pitch, and height, using the smallest porosity value. For example, the values of two of the parameters, e.g., height and pitch, can be fixed, with the value of the other parameter, column diameter, varied.

FIG. 4 is a plot of normalized fluid permeability, i.e., fluid permeability divided by the smallest calculated fluid permeability value, as a function of porosity for an array of circular columns with 10 μm pitch and arranged in a hexagonal array. As shown in the plot, the fluid permeability can be varied by more than 5 orders of magnitude by selecting the column diameter and column pitch to set the corresponding porosity. The ballasting structure of the invention therefore can be implemented as a hydraulic impedance to impose a wide range of flow rates.

Turning now to further specifics of the design of the ballasting structures of the invention, the ballasting structures of the invention are particularly amenable to microfabrication production and therefore can be scaled to the micron regime and the nano-regime. As explained in detail below, microelectronic materials, carbon nanotubes, and other such microstructures and nanostructures can be employed to form arrays of ballasting pillars or columns in accordance with the invention. Further as explained in detail below, microfabrication techniques allow the application of conformal functionalization coatings to the ballasting element and thus, enable the fluidic structure to accomplish a selected task.

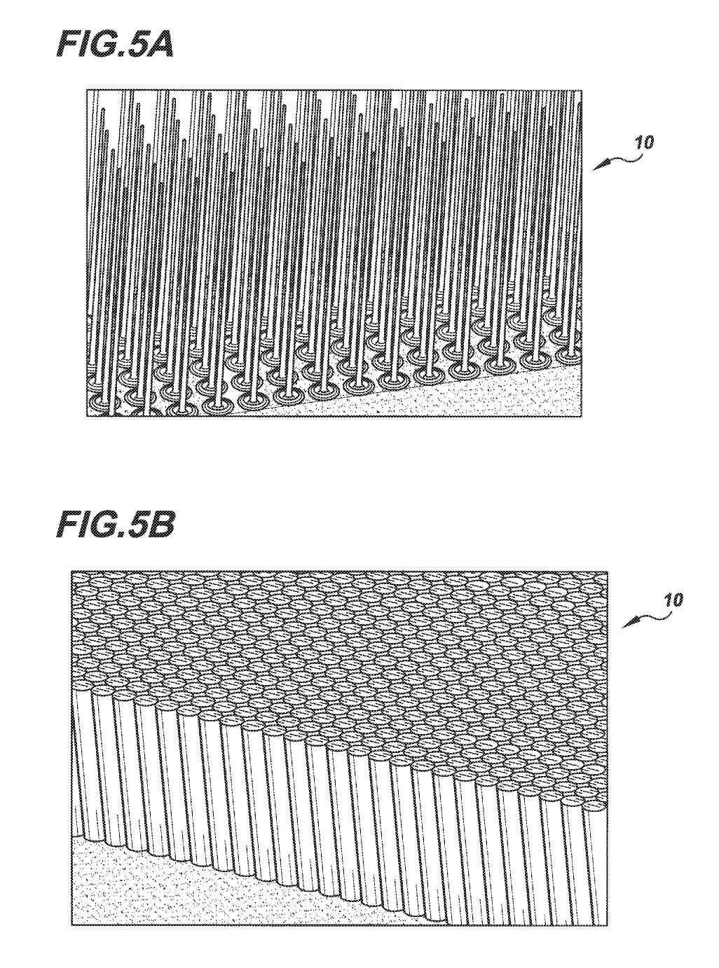

The precision of microfabrication technology is particularly advantageous for controlling the geometry of the ballasting structures of the invention to produce a selected fluidic pressure drop and flow rate with a high degree of accuracy. For example, referring to FIG. 5A there is shown a schematic view of a 1 cm×1 cm ballasting array of substantially square silicon columns produced in accordance with the invention. Each column is a 1 μm-wide square and is 100 μm-tall, and the column-to-column pitch is 10 μm. Based on the expressions above, this ballasting arrangement of the invention provides an effective hydraulic diameter of 110 μm. Now referring to FIG. 5B, there is shown a schematic view of the same 1 cm×1 cm ballasting array of square silicon columns shown in FIG. 5A, but here each column has been coated with a conformal layer to render each square column 9.9 μm-wide, instead of 1 μm-wide, while maintaining a 100 μm height and a 10 μm column-to-column pitch. Based on the expressions above, this second ballasting arrangement of the invention provides an effective hydraulic diameter of 0.2 μm, which is almost four orders of magnitude less than that of the example of FIG. 5A, using exactly the same column pitch.

This example demonstrates that by varying even only one of the pillar parameters of pitch, height, and width, an enormous range of hydraulic diameters, here four orders of magnitude, can be achieved by the ballasting structure of the invention. Because the hydraulic impedance of the ballasting structure is inversely proportional to the fourth order of the hydraulic diameter, as given by Expression (2) above, the four orders of magnitude range in hydraulic diameter corresponds to almost twelve orders of magnitude range in hydraulic impedance. Microfabrication and nanofabrication techniques are therefore preferred in accordance with the invention to enable the very precise production of both sparse and dense arrays of columns with small dimensions and reduced dimensional variation.

As explained previously, the columns of the ballasting array of the invention can be provided as square, rectangular, round, triangular, star, hexagonal, or other selected geometry, with that selected geometry being approximated as square or round for the expressions given above. Herein the term “column” is meant interchangeably with the term “pillar” or other protrusion provided from a planar surface. Also, the ballasting array can be provided in an open-channel configuration, acting like rocks at the bottom of an open flowing river as in the arrangement of FIG. 1B without a top surface or sidewalls around the flow path. The ballasting array can alternatively be provided in a closed-channel configuration, like that represented in FIG. 1C, where the fluid flow is through a closed volume in which the columns extend up to the full height of the volume. If the height of the columns is less than the full height of the closed channel, the resulting hydraulic impedance is the parallel combination of the two impedances corresponding to the column-filled channel region and the empty channel region, each having a different equivalent hydraulic diameter.

The ballasting array can be provided along a portion of a channel or other liquid flow path, at the beginning or end of the channel, or through the full extent of the channel. The length, L, through which a fluid must flow through the ballasting array to achieve a desired hydraulic impedance, is directly related to the effective hydraulic diameter, as in Expression (2) and (14) above, based on the pitch, width, and height of the columns of the array. Therefore, for a given channel length, L, these parameters of the column geometry can be selected such that the ballasting array provides the requisite impedance within the channel extent, either over the full extent or a portion thereof. It is to be recognized that a fluid flow must be fully developed through the ballasting structure to enable the design paradigm described above to be correct, and therefore a ballasting array of only one or two rows of columns is not in general sufficient. The prerequisite that the length, L>10×P, the pitch, ensures that fully developed flow is provided. The number of rows and columns can also be selected based on a desire to prevent fluid clogging, because the redundancy in flow paths that is formed between the columns of the array provides alternative paths that inhibit complete clogging of the fluid flow.

Whatever ballasting array geometry is selected, the ballasting array of the invention can be provided in any suitable fluid flow arrangement. As explained previously, the ballasting array can be provided in an open flow arrangement in which no confining top or walls to a fluid flow are imposed, as in FIG. 1B. The ballasting array can be provided in a semi-closed arrangement, such as a trench, groove, canal, gutter, or other such passage, or in a fluid path having a fully confining flow perimeter, such as a tube, capillary, channel, duct, conduit, or other such structure.

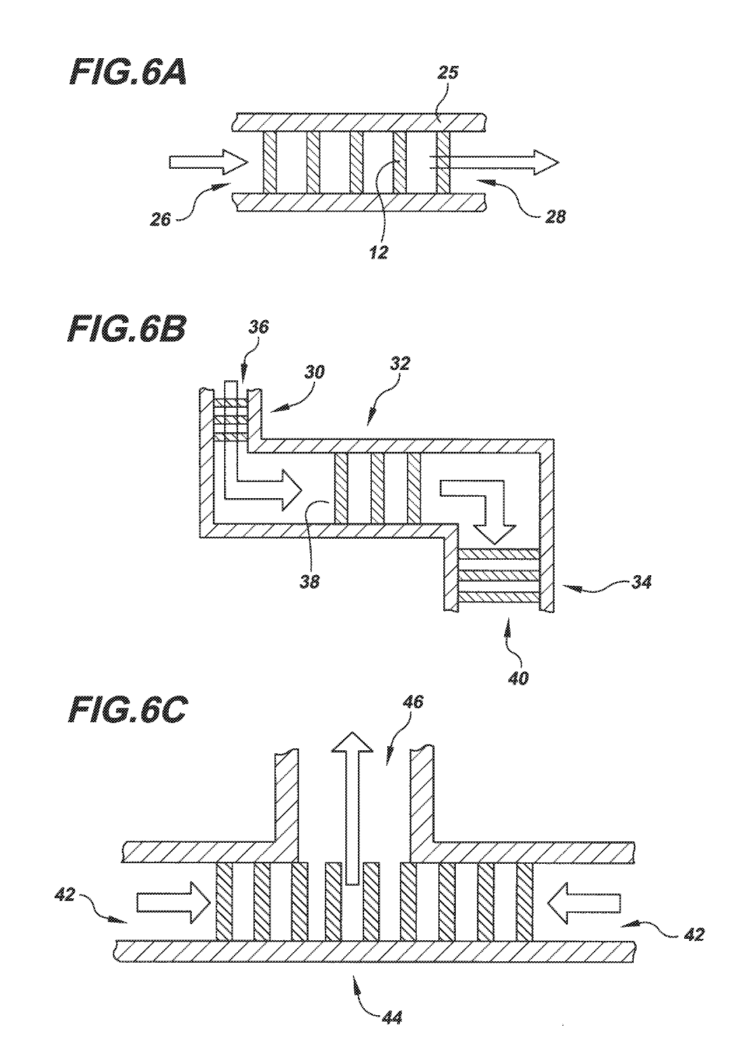

Referring to FIGS. 6A-6C, the ballasting array of the invention is not limited to a specific fluid flow configuration. For example, as shown in FIG. 6A, an array of columns 12 can be provided in a fluid flow channel 25 in which fluid is directed from a first opening, or inlet port 26, to a second opening, or outlet port 28. In the schematic views of FIGS. 6A-6C, a cross-section through a fluid flow configuration is shown with one row or column of pillars being illustrated for clarity. It is to be understood that in the drawings of FIGS. 6A-6C arrays of ballasting pillars are intended, not a single row or column of pillars.

As shown in FIG. 6B, multiple ballasting arrays can be provided along a fluid flow path at various points along the path. Here, e.g., a first ballasting array 30 can be provided at an inlet port 36, a second ballasting array 32 provided along a stretch of channel, and a third ballasting array 34 provided at an outlet port 40. Each ballasting array 30, 32, 34 can have a distinct height, width, and pitch such that each ballasting array provides a unique hydraulic impedance at a selection location along a fluidic flow path. Note in the example of FIG. 6B that the flow path need not be linear along its entire extent; making turns along the path.

As shown in FIG. 6C, the fluid flow can change directions in a ballasting array. For example, fluid inlet ports 42 can be provided at ends of a channel for fluid to flow inwardly through a ballasting array 44, at the center of which array the fluid flow changes direction to flow perpendicularly through out of the array to a perpendicular outlet port. These examples demonstrate that the ballasting array of the invention can be imposed in substantially any fluidic flow path, with the fluid flow changing direction at points in the array.

This flexibility in implementation of the ballasting array of the invention enables its application to a wide range of microscale and nanoscale fluidic systems. In one example system that is particularly well-addressed by the ballasting array of the invention, an array of microscale electrospray emitters are implemented with each emitter having a distinct ballasting array to produce requisite flow rate and pressure conditions specifically and independently for each emitter in the array.

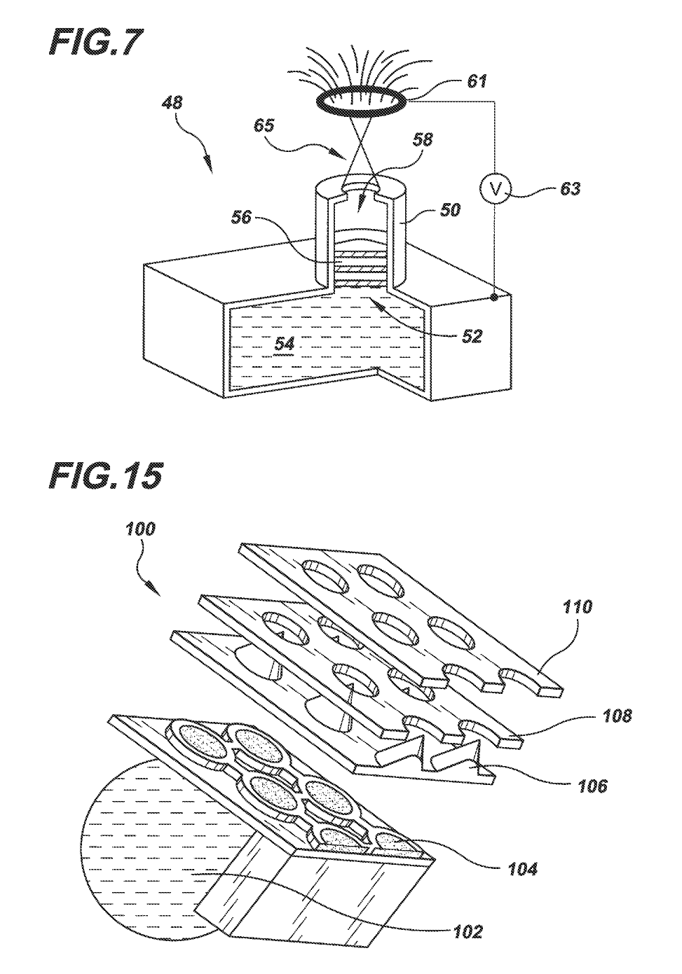

FIG. 7 is a schematic representation of an electrospray emitter 48 including a ballasting structure composed of an array of columns in accordance with the invention. The emitter is composed of a channel 50 that includes an input port 52 connected for delivery of a fluid from a reservoir 54 to the channel 50. The channel is at least partially filled with a ballasting array 56 of the invention, and an opening, or output port 58 with a diameter in principle different compared to the diameter of the channel. The emitter output port 58 is facing an electrode 61, and a bias voltage 63 is applied between the emitter and the electrode to cause formation of a so-called Taylor cone 65 of fluid for electrospray from the emitter.

The electrospray emitter of FIG. 7 can be very efficiently implemented in accordance with the invention as a microfabricated microscale structure provided in an array of microscale electrospray emitters. Microfabrication techniques for producing such an array as a microscale, silicon-based configuration are described in detail below.

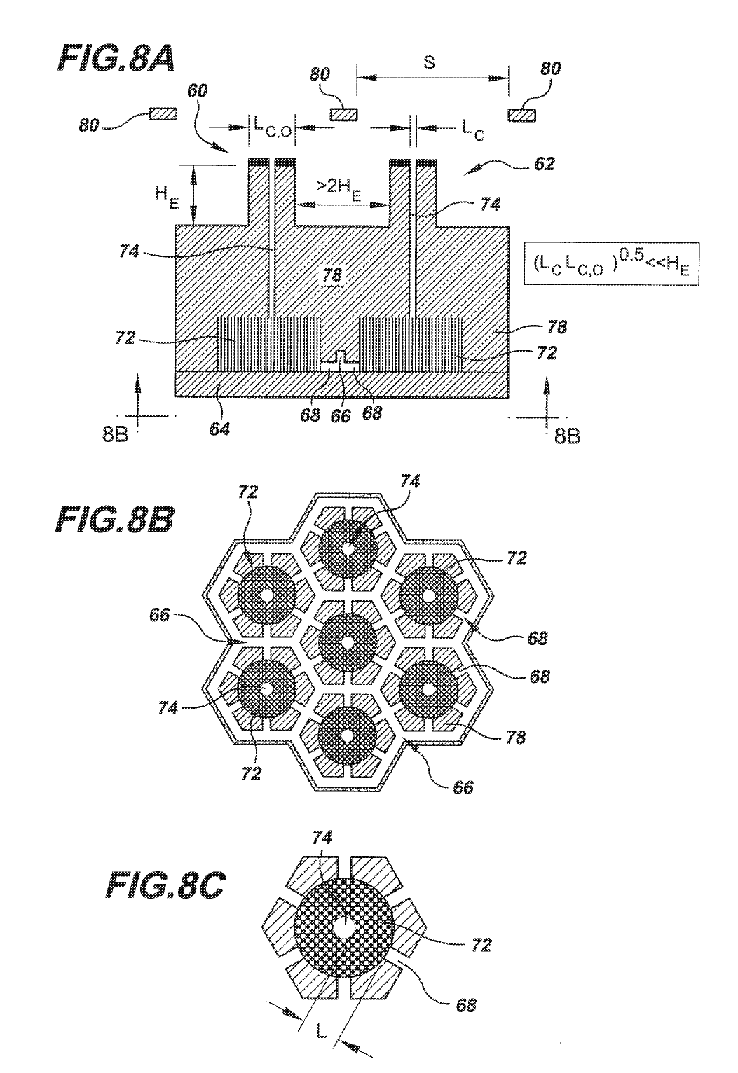

FIG. 8A is a schematic cross-sectional view of two such microscale electrospray emitters 60, 62 that are adjacent to each other in the array of emitters. FIG. 8B is a planar view of an array of ballasting structures for seven such microscale emitters with an optional sealing surface 64, provided for active pressure-drive system operation, removed for clarity for correspondence between the views. FIG. 8C is a similar planar view, here of a ballasting structure for only one emitter arrangement.

In the configuration of FIGS. 8A-8C, a flow reservoir bus 66 delivers fluid from a fluid plenum to a fluidic feed 68 connected to each emitter flow path. Each fluidic feed directs the fluid through a ballasting array 72 that is distinct for each corresponding emitter 60, 62, respectively. Each emitter is accordingly provided with a distinct flow path in which is provided an exclusive, dedicated ballasting array that is employed for flow through that emitter alone; i.e., each ballasting array supplies a flow rate to a single emitter. This configuration enables customization of each ballasting array for each emitter. The output of each ballasting array is directed through a channel 74 to internally feed a corresponding emitter.

In the example electrospray emitter configuration of FIGS. 8A-8C, each ballasting array 72 is configured as a set of columns arranged in a rectangular matrix with Cartesian spacing and constant square cross section. The array of emitters is configured with hexagonal packing to maximize emitter density for the array, but any array configuration can be employed. With the example hexagonal emitter design, each ballasting array 72 is similarly configured with a circular perimeter. The reservoir bus 66 delivering fluid to each ballasting array is preferably relatively wide to ensure that the fluidic pressure drop outside each ballasting array is substantially negligible. Each ballasting array is surrounded by structural material to provide mechanical protection and to facilitate bonding to a sealing substrate if such is desired.

With this arrangement, liquid flow through each ballasting array 72 is lateral, from the circular perimeter, inward, to the inner channel 74 for direction to an emitter. This arrangement is like that of FIG. 6C, in which fluid flow is lateral, from outer edges of a ballasting array to a central location at which the fluid turns perpendicularly to a perpendicular delivery channel, in this case to an emitter. Therefore, the radial distance, L, from the outer edge of the ballasting array to the central delivery channel 74 defines the extent of the flow path along with the hydraulic impedance and the corresponding fluidic pressure drop of that impedance to be specified. The column width, W, and pitch, P, of columns of the array are then selected based on the column height to deliver a desired pressure drop in the fluid flow to the emitter.

In one example design process for selecting these parameters for the electrospray emitter ballasting arrays, the electrical and mechanical features of the system can be first specified. In one example application, potable water is monitored. Potable water contains ions and thus as a polar solvent with high electrical permittivity is particularly well-suited for electrospray. The device is intended to work at atmospheric pressure, and have a no particle interception. The emitter architecture can be provided as, e.g., a gate grid, in which each emitter has a dedicated gate, or alternatively, a slotted gate, in which emitters are clustered into linear arrays that are under the influence of a common slot electrode, to enhance the emitter density at the expense of higher startup voltages. In either case, the startup voltage is

$${V}_{start} = \sqrt{\frac{γ \cdot {L}_{c , o}}{{ɛ}_{o}}} ln [ \frac{4 G}{\sqrt{{L}_{c} \cdot {L}_{c , o}}} ] \qquad ( 16 )$$

where γ is the surface tension of the liquid, ∈ₒ is the electrical permittivity of free space, G is the separation between the emitter and the electrode, L_{c} is the internal diameter of the emitter, and L_{c,o} is the external diameter of the emitter.

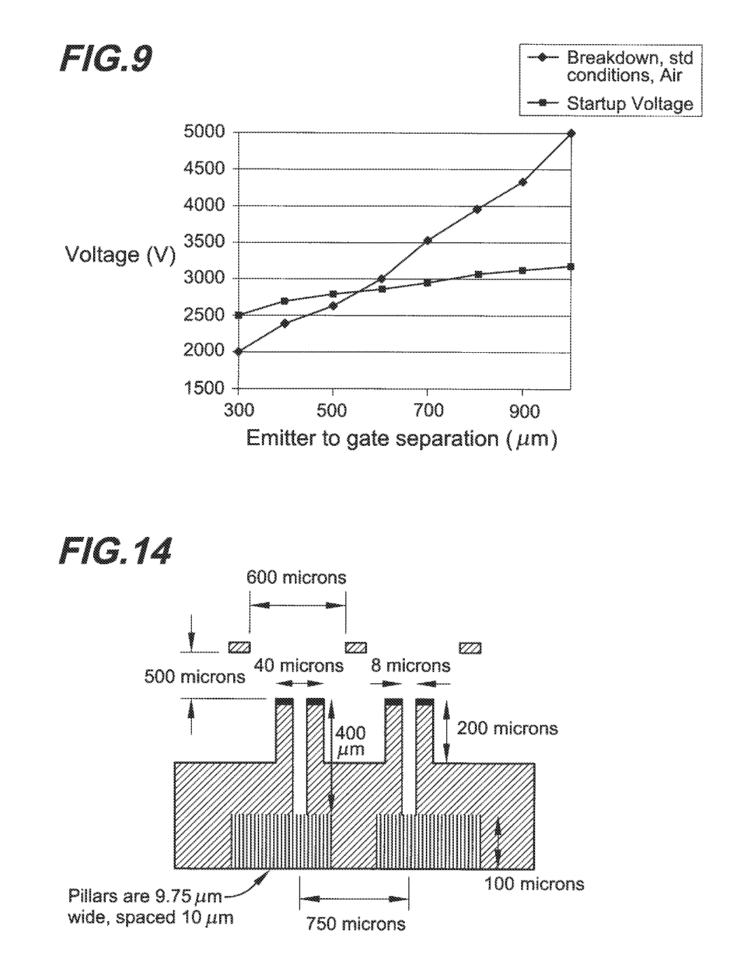

There is a trade-off between the requisite startup voltage and the minimum voltage for electrical breakdown. Paschen's law describes the electrical breakdown in gases. For air at standard conditions, the breakdown values have been tabulated. FIG. 9 is a plot of emitter startup voltage and a plot of breakdown in air, both as a function of emitter-to-electrode separation. This plot of FIG. 9 suggests that emitter-to-electrode distances larger than about 550 μm are needed to avoid electrical breakdown, and that electrospray startup occurs at a voltage of about 2750 V for an emitter with an external diameter, L_{c,o} equal to about 40 μm and an internal emitter diameter, L_{c} equal to about 5 μm, based on Expression (16) above.

The electrode-to-emitter distance is also related to emitter packing if particle interception is undesired. The electrospray plume is composed of charged particles, and thus Coulomb forces are present, making the plume spread. It is found that in general, electrospray emitters will produce a fan with semi angle smaller than 25°. This fan divergence requires a gate aperture that is 85% of the electrode-to-emitter separation. With the design parameters provided by the plot of FIG. 9, it is therefore determined that the grid can have an aperture diameter of at least about 47 μm, or slots that are 470 μm wide. In FIG. 8A, this second configuration is shown with slots, S, provided between adjacent electrodes

FIG. 8A also illustrates other design assumptions. For example, the design uses the proposition that two adjacent emitters with height H_{E} will not experience electric field reduction due to proximity if the emitters are spaced apart by a distance of at least about 2 H_{E}. If the emitter height, H_{E}=200 μm, and the emitter-to-emitter separation is 750 μm, then a slot aperture of about 600 μm can be employed, with a vertical emitter-to-gate separation of about 500 μm.

With this electrical insulation design in place, the ballasting arrays and the nozzle diameter for the emitters can be determined. To begin the ballasting design, the ejection flow rate for each emitter is first estimated. The current per-emitter, I, in single Taylor cone droplet emission regime is given by:

$$I = f ( ɛ ) \sqrt{\frac{γ \cdot K \cdot Q}{ɛ}} , \qquad ( 17 )$$

where K is the electrical conductivity of the liquid, here potable water, Q is the water flow rate through an emitter, and f(∈) is a dimensionless experimental function equal to a value of about 20 for a relative electrical permittivity larger than about 40. For an array of a number, n, of emitters, Expression (17) above represents the relationship between the total current and total flow rate for the array of emitters if a correction factor equal to n^{0.5} multiplies the right hand side of the equation. This demonstrates that there is a clear advantage in streaming a given flow rate through an array of emitters, rather than a single emitter, for achieving a higher current.

The ballasting array for each emitter is designed to produce a flow rate through each emitter that falls within the allowed range of flow rates per-emitter for steady operation of the emitter array. The smaller the flow rate per-emitter, the larger the specific charge, δ, in the emitter exit stream, which is desirable for signal amplification. The specific charge, δ, is given as:

$$δ = \frac{charge}{mass} = \frac{f ( ɛ )}{ρ} \sqrt{\frac{γ \cdot K}{ɛ \cdot Q}} , \qquad ( 18 )$$

where ρ is the liquid mass density. To maximize the specific charge, the minimum flow rate, Qₘᵢₙ, that can be steadily emitted by a single Taylor cone in droplet emission is given as:

$${Q}_{min} ≅ \frac{γ \cdot ɛ \cdot {ɛ}_{o}}{ρ \cdot K} \qquad ( 19 )$$

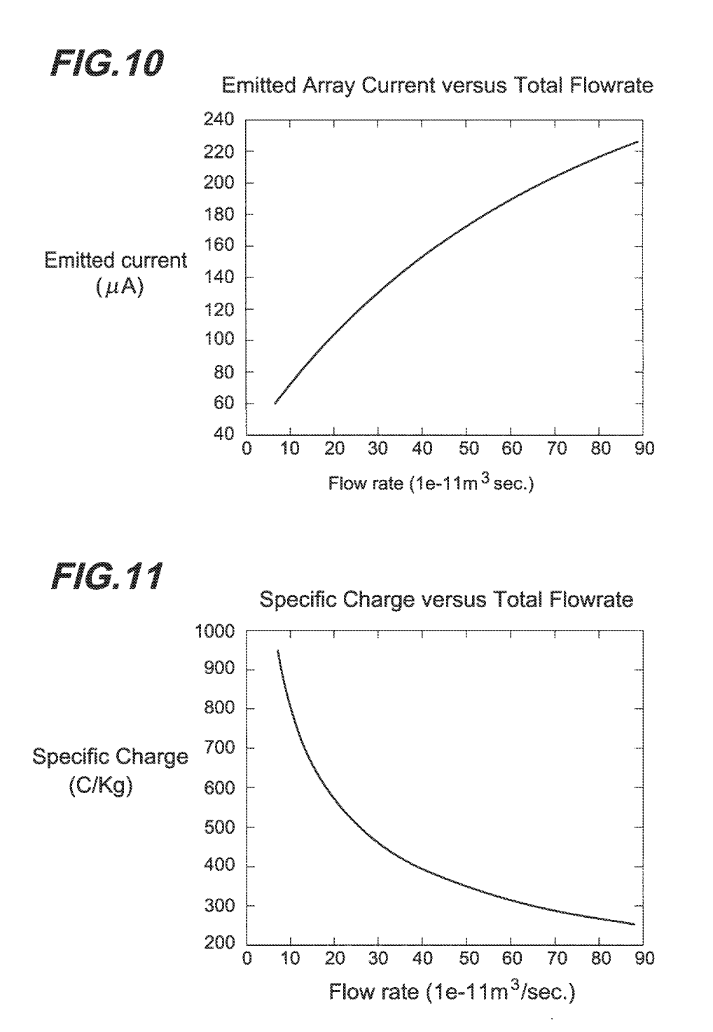

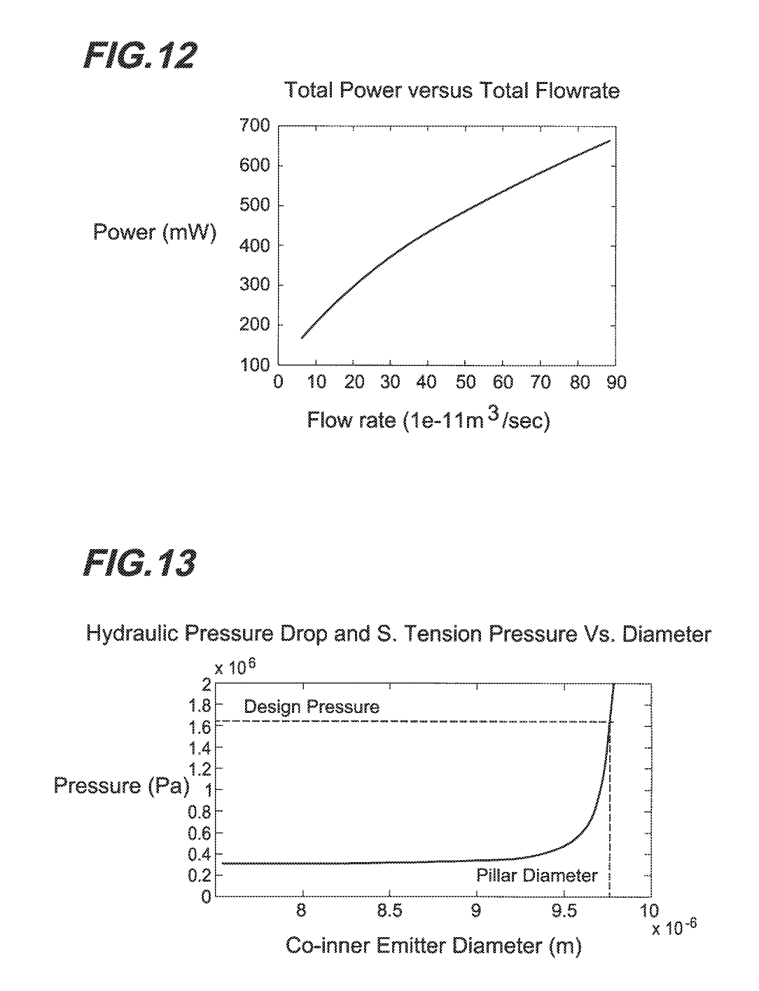

In general, it is preferable to operate as closely as possible to the minimum flow rate, Qₘᵢₙ, to maximize the specific charge, taking into account possible variations in the fluid properties and dimensional variability of the hydraulics, e.g., with a volumetric flow rate of 3 Qₘᵢₙ per-emitter. The plots of FIG. 10, FIG. 11, and FIG. 12 provide performance parameters for the design as a function of the flow rate per emitter. In these plots, it is assumed that the electrospray emitter array includes 500 emitters employing potable water with liquid electrical conductivity, K=0.04 Si/m, the surface tension of the liquid, γ=0.07 N/m, permittivity, ∈=80, and the flow rate through an emitter Q, falls within the Qₘᵢₙ to 15 Qₘᵢₙ range. In this example Qₘᵢₙ, per emitter=1.2390e⁻¹³ m³/sec and minimum current, Iₘᵢₙ, per emitter=0.12 μA.

With this specification, the plot of FIG. 10 provides the emitted current of the array as a function of total flow rate for a 500-emitter electrospray array. The plot of FIG. 11 provides the specific charge as a function of total flow rate for the electrospray array. The plot of FIG. 12 provides the total power as a function of total flow rate for the electrospray array operating at the startup voltage.

The invention provides a passive electrospray operational design that is particularly advantageous for many applications. With this passive operational control, the characteristic lengths of the hydraulics are selected so that the pressure needed to break up the liquid meniscus to overcome surface tension effects and form the Taylor cone of emitter spray is larger than the available pressure, in the fluid plenum or reservoir, and the viscous pressure drop to deliver a given flow rate once liquid is being sprayed. With this design, there is no flow from the emitter unless the electrostatic pressure provided by the electrode sufficiently assists the available pressure at the liquid plenum to produce a spray. In other words, only when an emitter electrode is energized and a bias voltage between the emitter and the electrode is applied does emitter produce flow, and the produced flow rate is the requisite electrospray beam.

To achieve this condition, for a meniscus confined in a circular tube, the maximum pressure before breakdown, P_{γ}, is given by:

$${P}_{r} ≅ \frac{4 γ}{ID} , \qquad ( 20 )$$

where ID is the internal diameter of the emitter. Given an emitter ballasting array similar to that of FIGS. 8A-8C, in which a radial flow field is imposed, then for a given flow rate, Q, through the ballasting array, a pressure difference, ΔP is required, given by:

$$Δ P = \frac{μ \cdot Q}{2 π \cdot H \cdot {K}_{p} \cdot Ξ} ln [ \frac{{r}_{ext}}{{r}_{int}} ] \qquad ( 21 )$$

where Kₚ is the fluid permeability of the ballasting array, μ is the fluid viscosity, H is the height of the pillars, rₑₓₜ, rᵢₙₜ are the external and internal radii of the ballasting array, respectively, producing the radial flow length, L, given in FIG. 8C, and Ξ is the fraction of polar angle taken up by the flow. In the example of FIGS. 8A-8C, Ξ is 1, whereby flow is coming uniformly from all directions). For a Newtonian liquid, the fluid permeability in this circular array of pillars with the assumption of hexagonal pillar packing as in Expression (15) above, each pillar having a diameter D, pitch, P, and height, H, is given by Expression (15) above, where Ω is the ratio between the column diameter and the column-to-column separation, i.e., Ω=D/P. From Expression (21), the hydraulic impedance is given as:

$${Z}_{H} = \frac{Δ P}{Q} = \frac{μ}{2 π \cdot H \cdot {K}_{p} \cdot Ξ} ln [ \frac{{r}_{ext}}{{r}_{int}} ] \qquad ( 22 )$$

In one design example, the pillar height, H=100 μm, P=10 μm, rₑₓₜ=250 μm and rᵢₙₜ=5 μm. Using Expression (20) above, a maximum pressure at the reservoir with respect to the atmospheric pressure can be specified if the emitter inner diameter is given. With the electrical insulation design given above, the emitter inner diameter is 8 μm, and the channel length is 400 μm, from ballast array output to emitter output. This design assumes that the surface tension of water, γ, is 0.072 N/m. From Expression (20), the maximum gauge pressure at the reservoir is then 36500 Pa, about one third of an atmosphere.

Given this maximum reservoir pressure, the design reservoir pressure is then specified as the maximum pressure divided by a safety factor, for, example, a safety factor of 2. In this case, the available pressure at the reservoir is set at 18250 Pa above the atmospheric pressure. When a voltage is applied between a gate and an emitter so that a Taylor cone is formed, this pressure of 18250 Pa at the reservoir is distributed between the ballasting array of the invention and the corresponding emitter channel.

This distribution in pressure sets the design parameters for the ballasting array. Water is a Newtonian liquid, and the pressure drop, P_{μ}, across a hydraulic impedance of length L, having a hydraulic diameter, D_{H}, and a flow rate, Q, of a liquid with viscosity, μ, for a laminar flow is given as:

$${P}_{μ} ≅ \frac{128}{π} \frac{μ \cdot L \cdot Q}{{D}_{H}^{4}} \qquad ( 23 )$$

For a water flow rate of 3 Qₘᵢₙ=3.75×10⁻¹³ m³/sec, viscosity equal to 0.001 Pa·s, the pressure drop across the emitter channel is 1493 Pa, i.e., 8.1% of the total pressure drop of the 18250 Pa from the reservoir. The pressure drop to be achieved by the ballasting array is the remainder of the 18250 Pa, that is, 16757 Pa. From Expression (21) above, with Ξ=1 and the geometry values previously given, the required fluid permeability of the ballasting array is given as 1.39×10⁻¹⁶ m².

With this specification, the pitch and width of the ballasting array are selected to produce the required pressure drop. For a pillar array with a pitch of 10 μm, the pillar diameter is then calculated to be 9.75 μm. FIG. 13 is a plot of the pressure dependence on the pillar diameter for this design example with the pitch set at 10 μm. This gives a complete design specification for the ballasting array geometry and the corresponding emitter geometry. FIG. 14 summarizes the quantitative results of this design process.

This design process can be conducted using, e.g., selected modeling software, such as MatLab™, from the MathWorks, Natick, Mass. As explained above, for pillars with arbitrary cross section, an approximate solution can be found by replacing the characteristic length of a square pillar cross section with an equivalent characteristic length for the selected cross-section computed using Expression (9) or (10). Also, Expression (15) above can be used to determine the parameters of the ballasting pillar array for a given permeability value if two of the three parameters (D_{W}, P, H) are proposed, and a numerical solution is obtained.

This design example demonstrates how the ballasting array of the invention can be precisely customized, through selection of column height, width, and pitch, to produce the hydraulic impedance and pressure drop that are specifically required for successful operation of a given macro/micro/nanoscale fluidic application. With the great flexibility provided by the design process, the ballasting array can be adapted for a wide range of diverse applications.

In a further example provided by the invention, the ballasting array can be used to implement an archetypical electrospray array 100 as shown in the exploded perspective view of FIG. 15. This system architecture includes a liquid reservoir 102, a network of ballasting elements 104 like that of FIGS. 8B-8C, and array of electrospray emitters 106, an extractor gate 108, for ionizing the liquid, and an acceleration gate 110 to collimate, accelerate/decelerate, or give a final speed to the ionized species. The emitters can be internally fed or externally fed. The emitters can be individually ballasted, with each emitter provided with a distinct ballasting array, or can be grouped in clusters with a common ballasting array feeding the cluster. The design process given above is employed for producing each ballasting array to provide a pre-established emitter output flow rate for a given pressure drop in each emitter.

Depending on the liquid to be employed, the archetypical electrospray head can be employed for coating, whereby the spray is used to cover a surface, or printing, e.g., to coat specific areas of a surface to generate a pattern. The ballasted electrospray head can also be used for, e.g., electrospinning a liquid, to generate fibers having nanometer-sized diameters; the electrospun fiber can be used for, e.g., tissue scaffolding, fluidic filters, or fabrication of parts such as capacitors and batteries. The electrospray head can also be employed for etching, e.g., with the electrospray fan made of a selected chemically active species to etch in-situ materials, or be provided with sufficient energy to etch materials by sputtering or milling. The electrospray head can also be employed for space propulsion, in which case the electrospray beam is employed for generating thrust in space by taking advantage of the property that electrospray can produce both polarities, thus obviating the need of external neutralization of the beam. In this last application, the ballasting array of the invention is particularly well-suited for enabling an ability to satisfy a wide range of specific impulse, Iₛₚ, required to accommodate a diverse set of missions. At low Iₛₚ, the propulsion system is required to provide efficient performance while delivering short-term, high impulse for missions such as Hommann transfers by using droplet emission with internally fed emitters. At high Iₛₚ, long-term missions such as orbital station keeping and deep space can be satisfied using ion emission from externally fed emitters. Such a space thruster consists of clusters of monolithic dense arrays of individually ballasted emitters that are capable of efficiently spanning a wide Iₛₚ range through flow and voltage control with the ballasting array of the invention.

Beyond the electrospray applications described above, the ballasting configuration of the invention can be adapted for chemical reactor applications, for fuel cell configurations, for biological cell and tissue environments, for liquid delivery by solid or hollow needle, for fluid spouting, and for other suitable applications.

With these examples, it is to be recognized that the ballasting array of the invention is not limited to microscale configurations and can also be implemented for macroscale fluidic applications. For example, chemical reactors, filters, ballasted manifolds, and other such structures can also be implemented at the macro-scale with the ballasting array of the invention, employing the design methodology given above.

Further in accordance with the invention, it is to be recognized that the ballasting array can be employed for control of gases as well as liquids. For example, there can be provided in accordance with the invention a chemical reactor that mixes either single-phase reactants, liquid or gas, or multi-phase, i.e., liquid/gas, reactants. The reactants mix into an array of reactor chambers that can be provided as, e.g., a packed bed, or any structure that allows species mixing and reaction of the species. The input feed of every species coming into each of the reactor chambers needs to be ballasted to achieve uniform operation of the reactor array and to dampen the instabilities that might arise from the reaction chambers. The ballasting array of the invention can be used to ballast the gas flow because the array can control any substance that has viscosity, a property that is consequence of entropy, i.e., such is present in all existing liquids describable by classical mechanics.

Turning now to examples of fabrication processes for producing the ballasting array of the invention, it is first to be recognized that the ballasting array can be formed of essentially any material system that is compatible with a fluid or gas intended to flow through the ballasting array. The columns, pillars, or in general, posts, protrusions, shafts, pilasters, or other structures, that constitute the array can be fabricated in any suitable and convenient manner and can be assembled within a flow path manually or by a selected fabrication sequence. The ballasting array structures therefore can be separate and distinct from the underlying support or substrate from which they protrude or can be formed integrally from that substrate.

For microscale applications, the invention provides microfabrication processes that are very practical and efficient for producing high-density, high aspect ratio, customizable array geometries. Microelectronic materials are for many applications preferable array materials because they enable monolithic microfabrication processes that can integrate a ballasting array with a microelectromechanical system (MEMS), such as an electrospray array, in a batch microfabrication process that achieves very tight dimensional tolerances for both microscale and nanoscale features of the systems. Fabrication substrates can be provided as semiconductor, polymer, ceramic, metallic, or other suitable substrate.

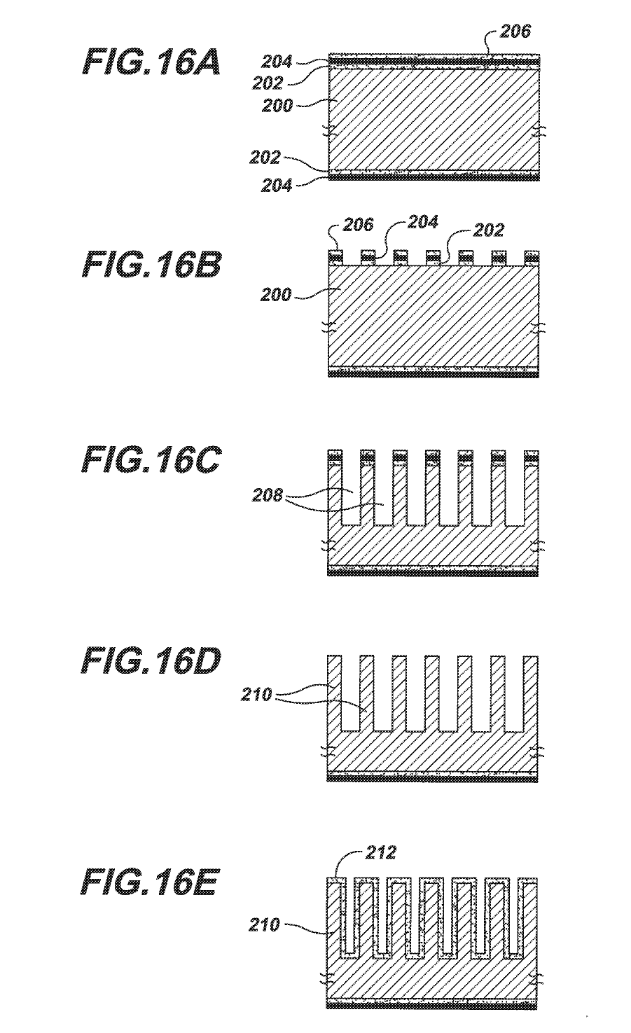

Referring now to FIGS. 16A-16E, in one example microfabrication process provided by the invention, silicon and silicon-based coatings are selected as the ballasting array materials, for compatibility with conventional micromachining and other microscale MEMS fabrication materials and systems. As shown in FIG. 16A, first a silicon wafer 200 is thermally oxidized to form a thermal oxide layer 202, of e.g., about 0.5 μm in thickness, on the top and bottom surfaces of the wafer 200. This thermal oxide layer 202 is employed in a later oxidation step to avoid the so-called “bird's beaking” that can occur during oxidation. Then a layer 204 of LPCVD silicon-rich silicon nitride, having a thickness of, e.g., about 0.5 μm, is deposited by over both the upper and lower thermal oxide layers 202. This silicon nitride layer is employed as a diffusion barrier in a later oxidation step. A layer 206 of PECVD silicon dioxide is then deposited on the top wafer layer 204 of silicon nitride and annealed in nitrogen to densify the layers and to expel hydrogen from the layers such that subsequent reactive ion etching (RIE) selectivity is enhanced.

Referring to FIG. 16B, the top surface of the wafer 200 is then coated with a suitable photoresist, and photolithographically a selected ballasting array geometry is transferred to the photoresist. Then the three-layer stack of PECVD silicon dioxide 206, silicon nitride 204, and thermal oxide 202 layers are etched, e.g., with RIE or other selected etch, to expose the surface of the wafer 200 as shown in FIG. 15B. Referring also to FIG. 16C, deep RIE (DRIE) or other selected etch process is then carried out to etch the silicon wafer to form trenches 208 having a depth selected to correspond to a desired height for the ballasting array. For example, a trench depth of 100 μm can be etched into the silicon wafer. If the photolithographic mask defines pillars having a 3.5 μm width, then a ballasting array hydraulic diameter of about 25 μm is produced for this geometry. With this trench etch complete, the silicon dioxide and silicon nitride layers are removed, and referring to FIG. 16D, if this geometry is sufficient for an intended application, then the ballasting array is complete. The side-view figures of FIGS. 16A-16E illustrate a cross-section through a ballasting array, so that only one row of the array is shown, but it is to be understood that a full array of columns and rows are produced by the process.

The invention provides processes for fine-tuning the geometry of a ballasting array, if desired, at this point in the process. Fabrication processes such as etching and coating can be employed to make the pillars larger or smaller in width and/or height. If it is desired to reduce the width of the ballasting array pillars slightly, to increase the effective hydraulic diameter of the array, then at the completion of the silicon trench etch, the wafer 200 is cleaned and then material is removed from the pillars. This removal can be accomplished by, e.g., direct etching of the silicon, by wet-oxidation of the silicon and then HF stripping of the oxide layer, or by other selected material removal technique. For example, if the pillar width is reduced from 3.5 μm to about 0.9 μm, the equivalent hydraulic diameter is increased to about 110 μm.

If material is to be added, rather than removed, from the pillars, then a coating or coatings of a selected material or materials can be deposited on the pillars. Multiple coatings of distinct materials can be employed if desired. In one example process, polysilicon is deposited on the silicon pillars by a LPCVD process. The polysilicon is then employed as the oxidation material in a subsequent wet oxidation step. With this arrangement, the polysilicon coating, rather than the silicon core of the pillars, is spent in the oxidation. Referring to FIG. 16E, a wet oxidation can be performed in the conventional manner to oxidize the polysilicon and produce an oxide coating 212 covering the pillars 210 to a selected extent for producing a desired ballasting array hydraulic diameter.

This example process demonstrates the microscale precision that can be achieved for producing a selected ballasting array geometry. The invention is not limited to this example process or materials. Silicon can be a preferably pillar material for microscale MEMS and nanosystems for which the pillars are integrated with the other structural components of the system. Silicon microfabrication technology enables the precise formation of very high aspect ratio silicon pillars by anisotropic wet etching, plasma etching, reactive ion etching, laser etching, and other well-controlled processes. Silicon dioxide is attractive as a pillar coating because it is inert and is excellent for wetting polar fluids. Silicon dioxide is also particularly effective because it can be easily produced in a conformal fashion on a silicon pillar with wet and/or dry oxidation.

But as explained previously, the ballasting array pillars and any coatings thereon can be produced of any material suitable for a given application. Depending on the application and the geometry of the ballasting array, LPCVD materials such as silicon nitride, silicon-rich nitride, polysilicon, or other material can be deposited on pillars. PECVD-formed materials such as silicon dioxide, silicon nitride, oxinitride or other dielectric materials, SiC, amorphous silicon, and other such materials can be formed. Further, there can be formed on the pillars metals, whether electrodeposited or electrode-less, such as nickel, chromium, gold, copper, or other metallic film. Chemical vapor deposition and other vapor deposition process can be employed to deposit, e.g., carbon nanotubes, organic dielectrics such as parylene, or other selected material. Atomic layer deposition (ALD) can be particularly well-suited for depositing materials, such as high-K dielectrics, on ballasting array pillars with atomic layer precision.

The invention contemplates the formation of a selected material layer on ballasting array pillars to achieve a range of functionality for the pillars of the array. For example, coating of ballasting array pillars with a highly polarizable substance such as gold enables fluidic flow of a liquid that is hard to wet. Non-wetting ballasting pillar surfaces can be created by conformally depositing on the pillars low free-energy materials such as polymers. Accordingly, hydrophobic or hydrophilic surfaces of the pillars can be produced to meet the conditions required for a given application.

Further in accordance with the invention, the surface of the ballasting array pillars can be functionalized to accomplish some specific task. For example, the ballasting array pillars can be coated with a selected substance that targets the mobility of a species in a fluid flow through the array, to implement a separation mechanism. Filtering of a fluid can similarly be accomplished by the ballasting array of the invention by either chemical functionalization of the pillars' surfaces, or by physical trapping of flowing particles due to the intricate hydraulic network of the ballasting array. In the latter case, the huge redundancy in flow paths of the ballasting array would circumvents potential global clogging problems. In addition, because the wettability of the ballasting pillars can be controlled by the application of selected conformal coatings, the same ballasting structure can be made wettable by liquids with very different surface tension values.

The ballasting array of the invention can further be produced of materials and structures that inherently form columns, e.g., in the manner of carbon nanotubes (CNTs). In accordance with the invention, carbon nanotubes extending vertically from a substrate can be employed as a ballasting pillar array. In one configuration of this implementation, pads of CNT forests are formed, with each CNT forest acting as a single ballasting array column. Once synthesized, each CNT forest can be coated with a conformal layer of material to fill in gaps between CNTs in the forest, thereby producing columns of multiple CNTs. For many applications, such a conformal layer is not required, however, because the CNT diameter and pitch in a CNT forest can be such that the viscous losses are so large within the forest compared to the exterior of the column that fluid will not flow through the forest, and thus, behave as a single structure. Alternatively, isolated individual CNTs can be employed as ballasting array columns, with each CNT functioning as a column of the array. In this case, conformal coatings can be applied to the synthesized CNTs to vary the column diameter for a given array pitch.

In either arrangement, in one fabrication example provided by the invention, catalyst pads are provided on a substrate on which the CNTs are to be synthesized. As in conventional CNT synthesis, for relatively small catalyst pads, single CNTs are generated, while for relatively larger catalyst pads, more than one CNT is grown on a given pad. In one example process, catalyst pads of, e.g., Ni, Co, Fe, Cu, or other suitable catalyst material, with nanometer-scale thickness are formed on a selected substrate. For example, a blanket coating of catalyst material can be formed on the substrate, e.g., by sputtering, evaporation, or other process, and subsequently lithographically patterned and etched, e.g., with a lift-off process, to remove the portions of the film so the array of catalyst pads is defined. CNT synthesis can then proceed in the conventional fashion. It can be preferred to employ plasma-enhanced chemical vapor deposition for CNT synthesis to cause CNT growth perpendicular to the substrate. After the CNT growth, conformal coatings like those described above can also be employed, if desired, to vary the column diameter.

This CNT column example demonstrates that a wide range of materials and structures can be employed to form the ballasting array columns of the invention. The invention is not limited to a particular column material or fabrication process. All that is required is the ability to select column width and height, and column array pitch, to achieve a prespecified pressure drop for a given fluid flow.

The description above provides demonstration that the exact specification of a ballasting array of the invention can be obtained to achieve a desired hydraulic diameter, D_{H}, and corresponding hydraulic impedance, Z_{H}, and pressure drop, ΔP, across the ballasting pillar array, for a flow rate, Q, of fluid through the array once an hydraulic ballasting element geometry is specified. The invention thereby provides the ability to a priori specify a desired pressure drop and flow rate and to enforce the desired pressure drop in a well-defined and reliable manner with the ballasting array of the invention.

It is recognized, of course, that those skilled in the art may make various modifications and additions to the embodiments described above without departing from the spirit and scope of the present contribution to the art. Accordingly, it is to be understood that the protection sought to be afforded hereby should be deemed to extend to the subject matter claims and all equivalents thereof fairly within the scope of the invention.

We claim:

1. Hydraulic ballast structure comprising:
an input port;
an output port through which a prespecified output flow rate is required; and
a ballasting array of columns disposed between the input port and the output port and having a cross-sectional column extent, W, a column pitch, P, and an array length, L, selected based on the required output flow rate, to produce a prespecified pressure drop that enforces the required output flow rate.

2. The hydraulic ballast structure of claim 1 wherein the column extent, W, is at least about 50% of column pitch, P.

3. The hydraulic ballast structure of claim 1 wherein the array length, L, is at least about 10 times the column pitch, P.

4. The hydraulic ballast structure of claim 1 wherein the ballasting array is characterized by a height, H, that is at least about 10 times the column extent, W.

5. The hydraulic ballast structure of claim 1 wherein the ballasting array is characterized by a height, H, that is substantially that height of an internal fluidic flow channel in which the ballasting array is disposed.

6. The hydraulic ballast structure of claim 1 wherein the ballasting array columns are substantially square.

7. The hydraulic ballast structure of claim 1 wherein the ballasting array columns are substantially round.

8. The hydraulic ballast structure of claim 1 wherein the ballasting array columns have a cross section that is star-shaped.

9. The hydraulic ballast structure of claim 1 wherein the ballasting array columns have a cross section that is hexagonal.

10. The hydraulic ballast structure of claim 1 wherein the input port is substantially parallel to the output port.

11. The hydraulic ballast structure of claim 1 wherein the input port is substantially perpendicular to the output port.

12. The hydraulic ballast structure of claim 1 wherein the ballasting array is substantially square.

13. The hydraulic ballast structure of claim 1 wherein the ballasting array is substantially circular.

14. The hydraulic ballast structure of claim 1 wherein the ballasting array is substantially hexagonal.

15. The hydraulic ballast structure of claim 1 wherein the ballasting array columns are substantially untapered.

16. The hydraulic ballast structure of claim 1 wherein the ballasting array columns are substantially tapered.

17. The hydraulic ballast structure of claim 1 wherein the ballasting array columns comprise a microelectronic material.

18. The hydraulic ballast structure of claim 1 wherein the ballasting array columns comprise silicon.

19. The hydraulic ballast structure of claim 1 wherein the ballasting array columns each comprise at least one carbon nanotube.

20. The hydraulic ballast structure of claim 1 wherein the ballasting array columns are disposed on a semiconductor substrate.

21. The hydraulic ballast structure of claim 20 wherein the semiconductor substrate comprises a silicon substrate.

22. The hydraulic ballast structure of claim 1 wherein the ballasting array columns are disposed on a polymer substrate.

23. The hydraulic ballast structure of claim 1 wherein the ballasting array columns are disposed on a ceramic substrate.

24. The hydraulic ballast structure of claim 1 wherein the ballasting array columns are disposed on a metallic substrate.

25. The hydraulic ballast structure of claim 1 wherein the ballasting array columns comprise a material layer coated on the columns.

26. The hydraulic ballast structure of claim 1 wherein the ballasting array columns include a metal coating.

27. The hydraulic ballast structure of claim 1 wherein the ballasting array columns include a dielectric coating.

28. The hydraulic ballast structure of claim 27 herein the dielectric coating comprises an oxide coating.

29. The hydraulic ballast structure of claim 27 wherein the dielectric coating comprises a nitride coating.

30. The hydraulic ballast structure of claim 1 wherein the ballasting array columns include a polysilicon coating.

31. The hydraulic ballast structure of claim 1 wherein the ballasting array columns include a plastic coating.

32. The hydraulic ballast structure of claim 1 wherein the ballasting array columns include a coating that is chemically functional for a fluid selected to flow through the ballasting array.

33. The hydraulic ballast structure of claim 1 wherein the ballasting array columns include a coating that targets the mobility of a species present in a fluid selected to flow through the ballasting array.

34. The hydraulic ballast structure of claim 1 wherein the ballasting array is characterized by a column pitch that is less than about 500 μm.

35. The hydraulic ballast structure of claim 1 wherein the ballasting array columns are characterized by a height that is less than about 1 millimeter.

36. The hydraulic ballast structure of claim 1 wherein the ballasting array columns cross-sectional extent is less than about 500 μm.

37. A fluidic element array comprising:
a plurality of fluidic elements, each element including an input port and an output port through which a prespecified output flow rate is required;
a reservoir connected for delivery of a fluid from the reservoir to each fluidic element input port; and
an hydraulic ballast structure provided for each fluidic element and connected between the input port and the output port of each fluidic element, distinct to that element, the hydraulic ballast structure comprising an array of columns having a column extent, W, a column pitch, P, and an array length, L, selected based on the required output flow rate of that element, to produce a prespecified pressure drop that enforces the required output flow rate for that element.

38. The fluidic element array of claim 37 wherein each output port comprises an electrospray emitter.

39. The fluidic element array of claim 37 wherein each output port comprises a chemical reactor.

40. The fluidic element array of claim 37 wherein each output port comprises a fuel cell.

41. The fluidic element array of claim 37 wherein each output port comprises a chamber for biological cells and tissues.

42. The fluidic element array of claim 37 wherein each output port comprises a hollow needle for liquid delivery.

43. The fluidic element array of claim 37 wherein each output port comprises a solid needle for liquid delivery.

44. The fluidic element array of claim 37 wherein each output port comprises a spout for fluid delivery.

45. The fluidic element array of claim 37 wherein the fluidic elements are disposed in a hexagonal arrangement.

46. The fluidic element array of claim 37 wherein the fluidic elements are disposed in a square arrangement.

47. The fluidic element array of claim 37 wherein the fluidic elements comprise a microelectronic material.

48. The fluidic element array of claim 37 wherein the fluidic elements comprise silicon.

49. The fluidic element array of claim 37 wherein the ballasting array columns comprise a material layer coated on the columns.

50. The fluidic element array of claim 37 wherein the ballasting array columns include a coating that is chemically functional for a selected fluid to flow through the ballasting array.
